(19) United States
(12) Patent Application Publication
(10) Pub. No.: US 2008/0215986 A1
(43) Pub. Date: Sep. 4, 2008

(54) DEVICE DIRECTED USER INTERFACE ELEMENTS FOR DATA HANDLING SYSTEM MANAGEMENT CONSOLE GRAPHICAL USER INTERFACE

(76) Inventors: JOSEPHINE FAITH BAYANG, Tucson, AZ (US); Melissa Jorgette Garcia, Tucson, AZ (US); Kevan Daniel Holdaway, Tucson, AZ (US); Andrew Gary Hourselt, Tucson, AZ (US)

Correspondence Address: JOHN H. HOLCOMBE;IBM CORPORATION, IP LAW DEPT., 8987 E. TANQUE VERDE RD., #309-374, TUCSON, AZ, 85749, US

(21) Appl. No.: 11/681,012

(22) Filed: Mar. 1, 2007

(51) Int. Cl. G06F 15/177

(52) U.S. Cl. 715/735

(57) ABSTRACT

A management console managing a data handling system stores user interface panel elements, and an attached device sends directions to the management console to select at least one of the stored user interface panel elements for a graphical user interface (GUI) panel for the device. The device sends directions to the management console to correlate at least one device command for the device to the GUI panel for the attached device; and the management console generates GUI panel(s) employing the selected user interface panel element(s); and calls commands in response to operation of inputs to the GUI panel(s), the correlated command being available to be called. Further, the attached device(s) send directions to the management console as to labeling of the GUI panel for the attached device; and the management console inserts label(s) in the user interface panel element per the labeling directions.

### FIELD OF THE INVENTION

This invention relates to management console graphical user interfaces for data handling systems, and, more particularly, to generation of the graphical user interfaces.

### BACKGROUND OF THE INVENTION

A management console of a data handling system acts as a systems management platform for devices of the data handling system. The management console may be designed to support a variety of devices, such as switches, device adapters, and storage. System management of each of these devices is very different and each has different functions which must be performed by an operator or administrator in order to configure, use and troubleshoot the device.

Data handling systems typically range from data centers located at one or more sites, major customer facilities, to groups of data processing, network, server, storage and/or other data handling devices. System management may be conducted either locally or remotely, or both.

Data handling systems typically require updating, changing or adding devices to the system. An updated, changed or added device may have different or added functionality from similar devices previously in the system, or may allow different or additional management of the device by the system operator. The management console may be designed to include expected changes in the future, but an updated, changed or added device may require a software update to the management console in order to provide user interface elements and the underlying function that is specific to that device.

### SUMMARY OF THE INVENTION

Data handling systems, devices and methods update the management console to provide the user interface elements for managing devices, even though the device may be updated, changed or added.

In one embodiment, a management console is configured to store user interface panel elements, to generate graphical user interface panels employing user interface panel elements, and to call commands in response to operation of inputs to graphical user interface panels.

An attached device is configured to send directions to the management console to select at least one of the stored user interface panel elements for a graphical user interface panel for the attached device, and to send directions to the management console to correlate at least one device command for the attached device to the graphical user interface panel for the attached device.

In another embodiment, the management console additionally is configured to insert labels in user interface panel elements; and the attached device is configured to send directions to the management console as to labeling of the graphical user interface panel for the attached device.

In a further embodiment, the attached device additionally is configured to provide to the management console the device command for the attached device for correlation.

In still another embodiment, the attached device is configured to send the directions to the management console as a formatted description.

In a further embodiment, the at least one device command comprises a command for operating a function of the attached device.

In a still further embodiment, the at least one device command comprises a command relating to the management of the attached device.

In another embodiment, a service method generates at least one graphical user interface panel of a management console for managing a data handling system. In the method, the management console stores user interface panel elements, and an attached device sends directions to the management console to select at least one of the stored user interface panel elements for a graphical user interface panel for the device. The device sends directions to the management console to correlate at least one device command for the device to the graphical user interface panel for the attached device; and the management console generates at least one graphical user interface panel employing at least the selected user interface panel element; and calls commands in response to operation of inputs to the at least one graphical user interface panel, of which commands the correlated command is available to be called.

In a further embodiment, the attached device(s) sends directions to the management console as to labeling of the graphical user interface panel for the attached device; and the management console inserts at least one label in at least one user interface panel element per the labeling directions.

In a still further embodiment, the attached device(s) additionally provides to the management console the at least one device command for the attached device.

In another embodiment, the attached device(s) is configured to send the directions to the management console as a formatted description.

In a further embodiment, the device command comprises a command for operating a function of the attached device.

In a still further embodiment, the device command comprises a command relating to the management of the attached device.

For a fuller understanding of the present invention, reference should be made to the following detailed description taken in conjunction with the accompanying drawings.

### BRIEF DESCRIPTION OF THE DRAWINGS

FIG. 1 is a block diagrammatic illustration of a data handling system having a management console and various devices which may implement the present invention;

FIG. 2 is a schematic block diagrammatic illustration of at least one device of FIG. 1;

FIG. 3 is a flow chart depicting embodiments of operation of the data handling system of FIG. 1 in accordance with the present invention; and

FIGS. 4, 5 and 6 are representations of GUI panels generated at the management console of FIGS. 1 and 3.

### DETAILED DESCRIPTION OF THE INVENTION

This invention is described in preferred embodiments in the following description with reference to the Figures, in which like numbers represent the same or similar elements. While this invention is described in terms of the best mode for achieving this invention's objectives, it will be appreciated by those skilled in the art that variations may be accomplished in view of these teachings without deviating from the spirit or scope of the invention.

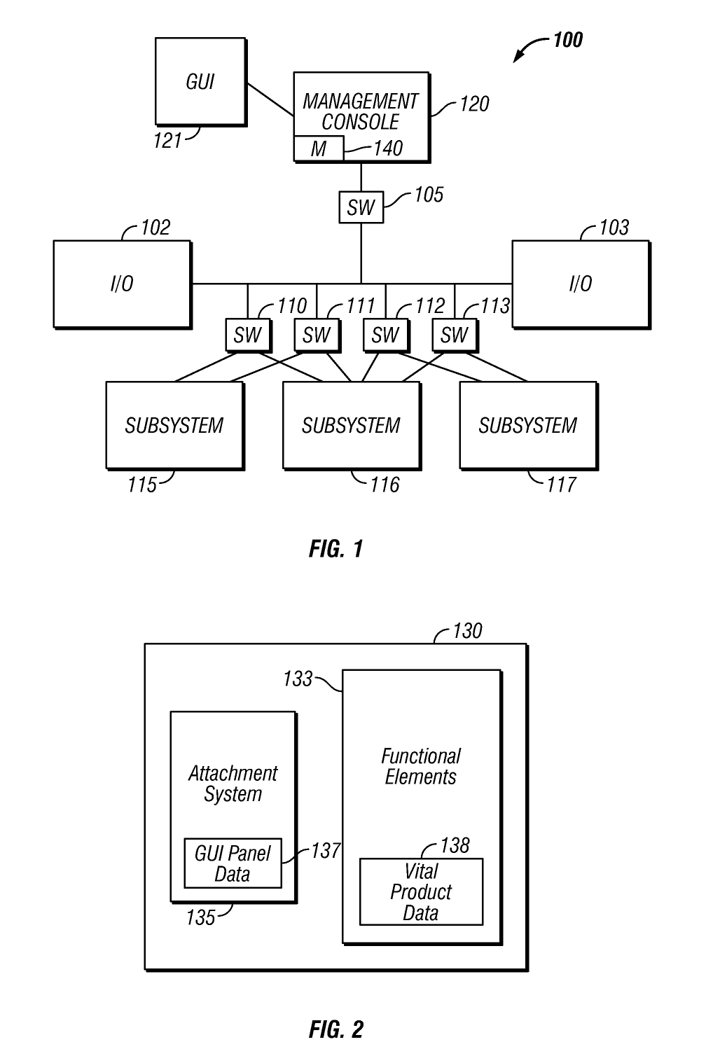

FIG. 1 illustrates an embodiment of a data handling system 100, configured with devices 102, 103, 105, 110, 111, 112, 113 and subsystems 115, 116, 117. One example of a data handling system 100 comprises a data storage system employing switches 110, 111, 112, 113 to handle the transfer and storage of data between input/output devices 102, 103, and data storage subsystems 115, 116, 117. Examples of data storage subsystems comprise automated data storage library subsystems such as the IBM® 3584 tape library subsystem, the IBM® 3494 virtual tape storage system, the IBM® Blade Center, etc. Other examples of data handling systems comprise data networks, data administration centers, call centers, etc.

Data handling systems typically require system management to track the devices making up the data handling system and their status, and to troubleshoot problems. A management console 120 acts as a systems management platform for devices of the data handling system. The management console may be designed to support a variety of devices, such as switches, device adapters, and storage. System management of each of these devices is very different and each has different functions which must be performed by an operator or administrator in order to configure, use and troubleshoot the device, using a graphical user interface (GUI) 121 including for example, one or more displays, keyboards, mice, etc. Examples of management consoles with GUIs comprise personal computers (PCs), dedicated terminals, etc., as is known to those of skill in the art.

A dynamic system 100 typically requires updating, changing or adding devices to the system. An updated, changed or added device may have different or added functionality from similar devices previously in the system, or may allow different or additional management of the device by the system operator. The management console may be designed to include expected changes in the future.

In one example, if the updated device has an additional component similar to existing components of the original device, the existing GUI functions can possibly be employed. However, if the updated, changed or added device has a new function, the management console may require a software update in order to provide user interface elements and the underlying function that is specific to that device.

Referring to FIGS. 1 and 2, at least one of the devices 102, 103, 105, 110, 111, 112, 113, 115, 116, 117, comprises device 130 having at least one functional element 133 that provides the functions of the device for the data handling system, and an attachment system 135. The attachment system may comprise some of the same constituents as the functional elements 133, or may comprise wholly or partially separate constituents. The attachment system may comprise memory, processing capability and device input/output capability, as are known to those of skill in the art, and may comprise code provided as an application or a special code implementation, or may comprise firmware, as is known to those of skill in the art.

The management console 120 may comprise a separate computer processor and GUI display 121 or may comprise applications operating on a single processor or processor system of the data handling system 100. The processor or processor system comprises logic and/or one or more microprocessors with memory, such as memory 140 for storing information and program information for operating the processor(s). Herein “processor” or “control” may comprise any suitable logic, programmable logic, microprocessor, and associated or internal memory for responding to program instructions, and the associated or internal memory may comprise fixed or rewritable memory or data storage devices. The program information may comprise a computer program product tangibly embodied on a computer useable medium, such as a host memory or a data storage drive or disk array, or by a floppy or optical disk, or by a cartridge, or other suitable medium, and be supplied to the management console 120 or memory 140 from an external interface 102, 103, for example from or by a web user interface or other network connection, or by any other suitable means. As one example, the program information computer useable program code is configured to operate the management console 120.

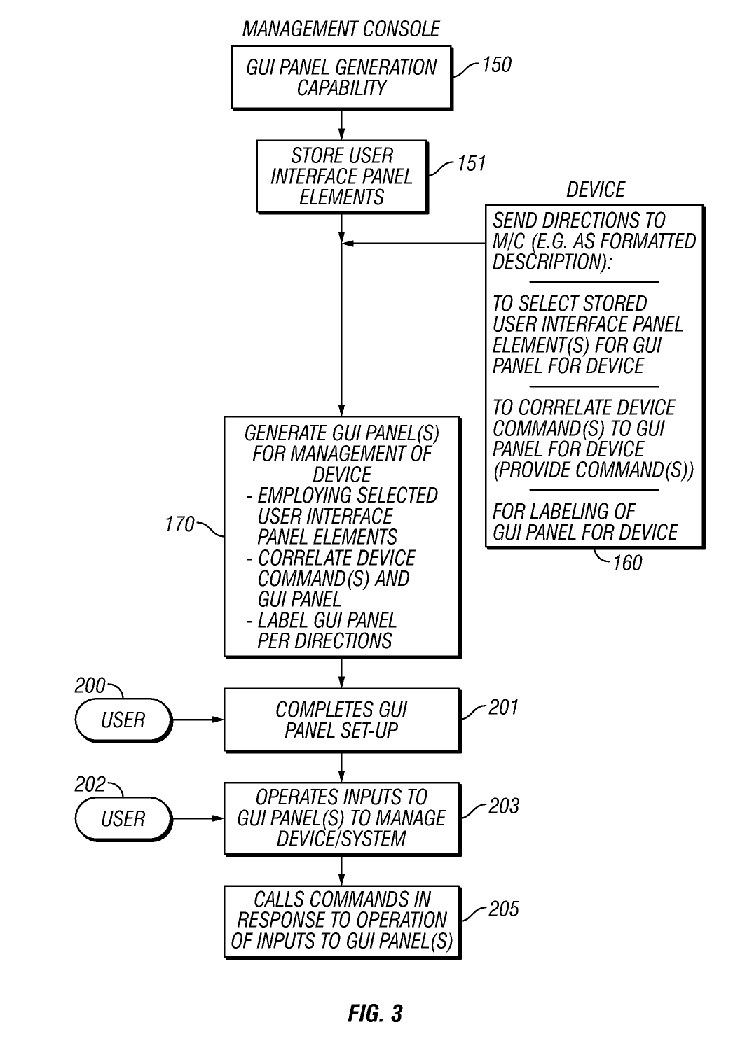

Referring to FIGS. 1, 2 and 3, in initial steps 150 and 151, the management console 120 is provided with the program code for generating graphical user interface panels employing user interface panel elements, and with user interface panel elements, for example, stored at memory 140. The program code may comprise an application or a special code implementation etc., as discussed above.

Examples of interface panel elements comprise text boxes which may serve as areas to contain or provide input information or labels; buttons that may be selected, for example by a mouse, and which may be labeled; text information areas; and indicators.

The attachment system 135 of the exemplary device 130 may comprise memory and an external interface. The memory may comprise non-volatile data storage, such as a memory system having a battery backup that protects data even if power is lost, flash PROM, EEPROM, disk drive, or other suitable non-volatile memory, as are known to those of skill in the art. The external interface may provide logic for handling data transfer with respect to the management console and may comprise one or more Fibre Channel ports, one or more FICON ports, one or more ESCON ports, one or more SCSI ports, or other suitable ports, all as are known to those of skill in the art.

The attachment system 135 stores directions 137 to be supplied to the management console for generating at least one graphical user interface panel relating to the device 130, as will be discussed.

Referring to FIGS. 1, 2 and 3, in initial steps 150 and 151, the management console 120 is provided with program code for generating graphical user interface panels employing user interface panel elements, and with user interface panel elements. Examples of interface panel elements comprise text boxes which may serve as areas to contain or provide input information or labels; buttons that may be selected, for example by a mouse, and which may be labeled; text information areas; and indicators, which also may be labeled.

The management console is additionally provided, in step 150, with program code for calling commands in response to operation of inputs to graphical user interface panels.

A device 130 may be attached to the data handling system 100 as a new device, as a replacement device, or as a modification to a device currently or previously attached to the data handling system. Typically, the management console 120 tests whether the device can be contacted, and, if so, contacts the device to request its Vital Product Data (VPD) 138. The management console adds the device's address to a list of managed devices and inserts information based on the VPD that was returned. The management console may also inform the user, for example, at the GUI 121, whether or not the device responded.

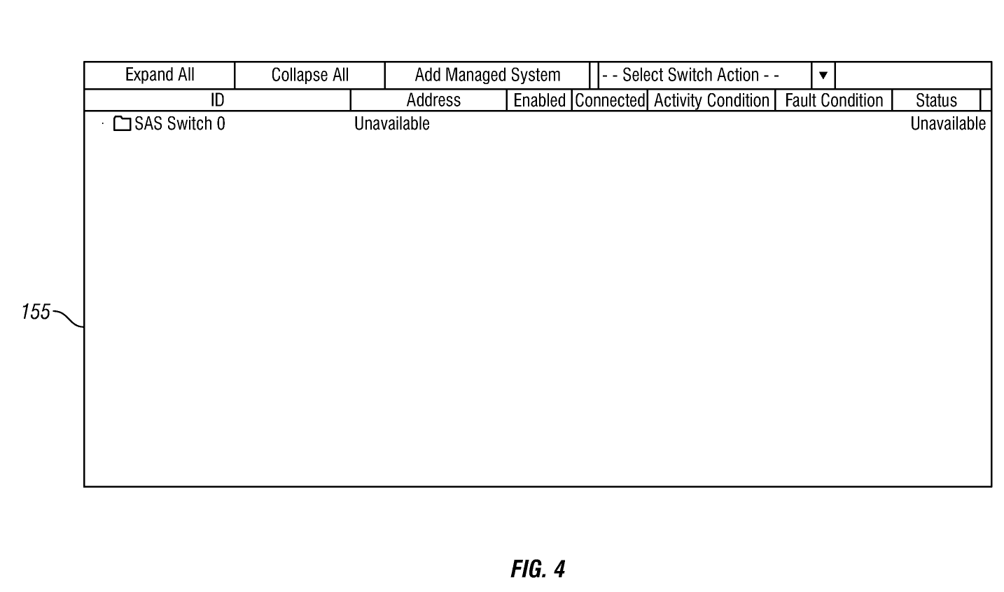

The GUI display 155 of FIG. 4 is for a device 130 that is not currently supported by the interface. Without having preexisting information of the manageable attributes of the device, the management console 120 cannot build information or populate the GUI with any options for management. In FIG. 4, the device that is the subject of the GUI display is a switch, such as one of switches 105, 110, 111, 112, 113, of FIG. 1.

In step 160, the attached device 130, for example, in response to the attachment request from the management console 120, sends directions and information to the management console. The directions are stored by and supplied from the device attachment system 135. The directions comprise directions to the management console 120 to select at least one of the stored user interface panel elements for a graphical user interface panel for the device. The directions may also comprise directions to the management console to correlate at least one device command for the device to the graphical user interface panel for the attached device. The stored directions may further comprise directions to the management console as to labeling of the graphical user interface panel for the attached device. The information may comprise information about the device and its status.

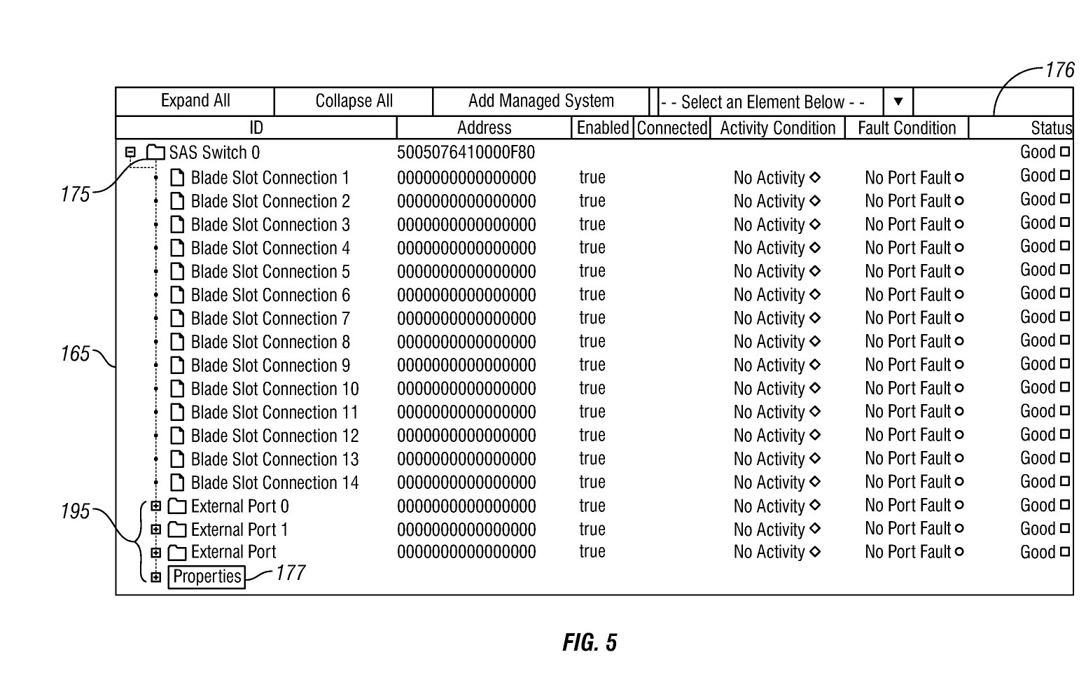

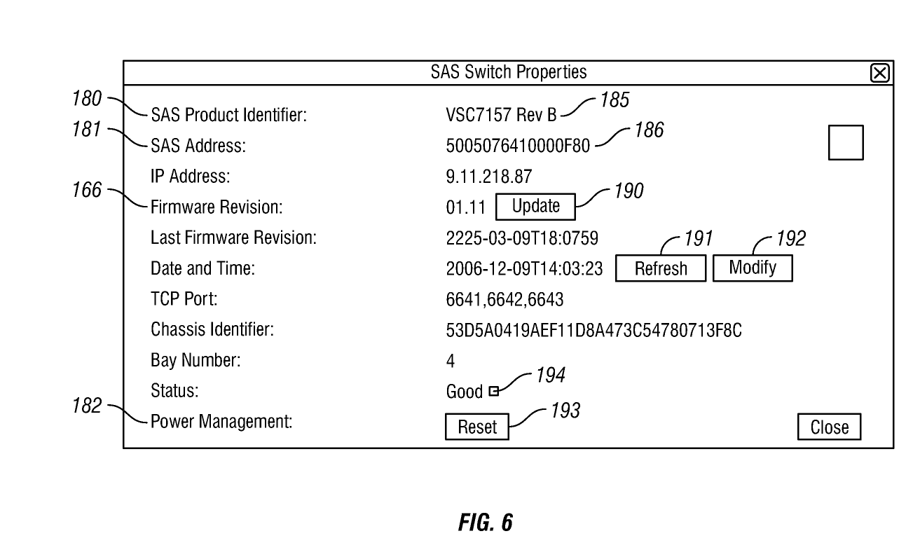

The device directions to the management console 120 are to select at least one of the stored user interface panel elements for a graphical user interface panel for the device, and the information comprises information to include in the GUI panel(s), such as GUI panels 165 of FIGS. 5 and 166 of FIG. 6. In one embodiment, the device sends the directions and information to the management console as a formatted description, such as an XML (extensible markup language) document. For example, step 160 may comprise the device sending the information to the management console user interface as part of the device discovery process, which may comprise an XML document with a root element <device>. Any other suitable format may also be employed, as is known to those of skill in the art. In FIGS. 5 and 6, the device that is the subject of the GUI display is a switch, such as one of switches 105, 110, 111, 112, 113, of FIG. 1.

The device, also in step 160, sends directions to the management console to correlate at least one device command for the device to the graphical user interface panel for the attached device.

The device 130 may additionally send directions to the management console as to labeling of the graphical user interface panel for the attached device.

The management console 120, in step 170, generates at least one graphical user interface panel employing at least the selected user interface panel element, such as GUI panels 165 of FIGS. 5 and 166 of FIG. 6. Examples of user interface panel elements comprise a button 175 to select a listing having indicators 176, and a button 177 to select a new GUI panel 166. In the GUI panel 166, user interface panel elements may comprise text boxes, such as text boxes 180, 181 and 182, text information areas 185 and 186, buttons 190, 191, 192 and 193, and indicator 194, and the provided labels are for the text boxes, buttons and indicator.

An example of directions in an XML format comprises:

<device name=“//storage/sas/sasswitch” version=“1”>
<panels>

<panel name=“sasswitch_properties”>

<text name=“vpd_product_id”
valueRef=./vpd/product_id[0]”>
<label>SAS Product Identifier</label> <text>
<text name=“vpd_sas_address”
valueRef=“./vpd/sas_address [0]”> <label>SAS
Address</label> <text>
<text name=“sensors_status” valueRef=“./sensors/status”>
<label>Status</label> <test>
<button funcRef=“/UI_ROOT/closeDialog” > </button>

</panel>

</panels>
</device>

In the above example, each user interface element references data (valueRef) or functions (funcRef) using tree-based accessing commands as are known to those of skill in the art.

The management console 120 has stored the user interface panel elements, for example, in memory 140, and, in response to the directions from the attached device 130, selects stored user interface panel elements for a graphical user interface panel for the device, generating the GUI panel(s) employing the selected user interface panel elements and attaches the directed labels, forming the GUI panels for the device.

The management console 120 correlates at least one device command for the device to the graphical user interface panel for the attached device. The commands either obtain information from the device or cause an operation of the device.

In the above example, <textvalueRef=″./vpd/sas_address[0]″><label>SAS Address</label></text> is telling the management console to look for a relative element in the tree to the current element (the current device) in the device's data and function connections, as is known to those of skill in the art. Here it is looking in the “vpd” (vital product data) branch, for an element called “sas_address”. The label for the text element is attached to the text element by enclosing a <label> element within the <text> element. As an example, text information area 186 is formed by the management console processor:

SAS Address: <span id=“device0_vpd_sas_address”>5005076410000F80<span>

Elements that occur multiple times, for example a ports list 195 is included employing queries that result in multiple elements as known to those of skill in the art. For example:

<tableRow name=“internal_port_row” valueRef“./components/port”>

<column attribute=“isEnabled”/>
<column attribute=“address”/>

</tableRow>

An example of data representation that is used in the table element may comprise the device's state:

<components>

<powerSupply> ... </powerSupply>
<fan> ... <fan>
...
<port isEnabled=“true” type=“blade” address=“12345” />
<port isEnabled=“true” type=“blade” address=“12346” />
<port isEnabled=“false” type=“external” address=“00000” />
...

</components>

The query in the <tableRow> element results in commands relating to multiple <port> elements and therefore multiple rows of information are inserted into the panel the management console 120 generates in panel 165.

As another example, a function “button funcRef” provides a command causing an operation of the device, such as to operate a reset function of the device, for example, by operation of button 193:

<button funcRef=″./function/power_management/reset″/>

The existing function of the device that is invoked is indicated by an identifier beginning with the dot slash “./” pointer. Actual queries or commands need not begin with a pointer as employed here, as is known to those of skill in the art.

A tag for a command to open a new function, such as opening panel 166 may be by use of button 177 of panel 165:

<funcArgs id=“openPropertiesArgs”/>

<arg name=“panel_name”>sasswitch_properties</arg>

</funcArgs>
<dropdownMenu>

...
<option funcRef=37 UI_ROOT/functions/openDialog”
funcArgs=openPropertiesArgs”/>

<dropdownMenu>

This tag contains a “funcRef” command as well as a reference to a funcArgs element that is elsewhere in the formatted document provided as the directions from the device 130 which tells the management console “UI” to invoke a function with the argument “panel_name” set to “sasswitch_properties” and which launches the dialog of panel 166.

The user 200, in step 201, may provide any additional information or set up commands, and the management console 120 completes the set-up of the graphical user interface panel(s) for the GUI 121 for the device.

With the set-up completed, the user 202 (does not have to be the same user as user 200) may operate the management console 120 and GUI 121 in step 203, and the management console, in step 205, calls the commands correlated by the management console that are operated by the user, for example, operation of a mouse. Steps 202, 203 and 205 continue and repeat for all of the management operations directed by the user.

Those of skill in the art will understand that changes may be made with respect to the methods discussed above, including changes to the ordering of the steps, or the removal of various steps. Further, those of skill in the art will understand that differing specific component arrangements may be employed than those illustrated herein.

While the preferred embodiments of the present invention have been illustrated in detail, it should be apparent that modifications and adaptations to those embodiments may occur to one skilled in the art without departing from the scope of the present invention as set forth in the following claims.

What is claimed is:

1. A data handling system comprising:
a management console configured to store user interface panel elements, to generate graphical user interface panels employing user interface panel elements, and to call commands in response to operation of inputs to graphical user interface panels; and
at least one attached device configured to send directions to said management console to select at least one of said stored user interface panel elements for a graphical user interface panel for said attached device, and to send directions to said management console to correlate at least one device command for said attached device to said graphical user interface panel for said attached device.

2. The data handling system of claim 1, wherein:
said management console additionally is configured to insert labels in user interface panel elements; and
said at least one attached device is configured to send directions to said management console as to labeling of said graphical user interface panel for said attached device.

3. The data handling system of claim 2, wherein said at least one attached device additionally is configured to provide to said management console said at least one device command for said attached device.

4. The data handling system of claim 3, wherein said at least one attached device is configured to send said directions to said management console as a formatted description.

5. The data handling system of claim 4, wherein said at least one device command comprises a command for operating a function of said attached device.

6. The data handling system of claim 4, wherein said at least one device command comprises a command relating to the management of said attached device.

7. A device configured for attachment to a data handling system, said data handling system comprising a management console configured to store user interface panel elements, to generate graphical user interface panels employing user interface panel elements, and to call commands in response to operation of inputs to graphical user interface panels; said device comprising:
at least one functional element configured to provide at least one function for said data handling system; and
an attachment system configured to send directions to said management console to select at least one of said stored user interface panel elements for a graphical user interface panel for said attached device, and to send directions to said management console to correlate at least one device command for said attached device to said graphical user interface panel for said attached device.

8. The device of claim 7, wherein:
said data handling system management console is configured to insert labels in user interface panel elements; and
said attachment system is configured to send directions to said management console as to labeling of said graphical user interface panel for said attached device.

9. The device of claim 8, wherein said attachment system additionally is configured to provide to said management console said at least one device command for said attached device.

10. The device of claim 9, wherein said attachment system is configured to send said directions to said management console as a formatted description.

11. The device of claim 10, wherein said at least one device command comprises a command for operating a function of said attached device.

12. The device of claim 10, wherein said at least one device command comprises a command relating to the management of said attached device.

13. A service method for generating at least one graphical user interface panel of a management console for managing a data handling system comprising at least one device, comprising the steps of:
storing user interface panel elements;
said at least one device sending directions to said management console to select at least one of said stored user interface panel elements for a graphical user interface panel for said device;
said at least one device sending directions to said management console to correlate at least one device command for said attached device to said graphical user interface panel for said attached device;
generating at least one graphical user interface panel employing at least said selected user interface panel element; and
calling commands in response to operation of inputs to said at least one graphical user interface panel, of which commands said correlated command is available to be called.

14. The method of claim 13, additionally comprising the steps of:
said at least one attached device sending directions to said management console as to labeling of said graphical user interface panel for said attached device; and
inserting at least one label in at least one user interface panel element per said labeling directions.

15. The method of claim 14, additionally comprising the step of said at least one attached device additionally providing to said management console said at least one device command for said attached device.

16. The method of claim 15, wherein said at least one attached device is configured to send said directions to said management console as a formatted description.

17. The method of claim 16, wherein said at least one device command comprises a command for operating a function of said attached device.

18. The method of claim 16, wherein said at least one device command comprises a command relating to the management of said attached device.
